(19) United States
(12) Patent Application Publication
(10) Pub. No.: US 2021/0256890 A1
(43) Pub. Date: Aug. 19, 2021

(54) DRIVING CIRCUIT, DRIVING METHOD, AND DISPLAY DEVICE

(71) Applicant: TCL CHINA START OPTOELECTRONICS TECHNOLOGY CO., LTD., Shenzhen (CN)

(72) Inventors: Wenfang LI, Shenzhen (CN); Dan CAO, Shenzhen (CN)

(73) Assignee: TCL CHINA STAR OPTOELECTRONICS TECHNOLOGY CO., LTD., Shenzhen (CN)

(21) Appl. No.: 16/627,300

(22) PCT Filed: Dec. 13, 2019
(86) PCT No.: PCT/CN2019/125169

§ 371 Date: Dec. 29, 2019

(30) Foreign Application Priority Data
Nov. 29, 2019 (CN) 201911198847.4

(51) Int. Cl. G09G 3/20

(52) U.S. Cl. CPC G09G 3/20; G09G 2310/08; G09G 2310/0286; G09G 2330/021

(57) ABSTRACT

A driving circuit, a driving method, and a display device are provided. The driving circuit is applied to a display panel. The driving circuit sets a control module, so that when a current value of the control module on a common voltage driving module is greater than a preset value, a power management chip is controlled to stop outputting a common voltage, so that when a current on a common voltage line is large, an output voltage to the common voltage driving module is stopped, thereby avoiding a phenomenon that a melting screen damages a display screen due to large current.

### FIELD OF INVENTION

The present disclosure relates to the field of display technologies, and more particularly to a driving circuit, a driving method, and a display device.

### BACKGROUND OF INVENTION

In a driving circuit of an existing display screen, a power control chip and a level conversion circuit are used to transmit voltage signal, and each channel of the level conversion circuit is detected. When a large current occurs, the level conversion circuit is turned off for overcurrent protection of high and low potential voltages. However, during a signal transmission process, due to particles and other foreign objects appearing in the display screen, between clock signal lines or between the clock signal lines and common voltage lines are short-circuited, resulting in a large current on the common voltage lines, causing temperature in a display panel to rise, causing the display screen to melt and causing damage to the display screen.

Therefore, an existing driving circuit has the technical problem that current on the common voltage line is relatively large and the display screen is damaged.

### SUMMARY OF INVENTION

An embodiment of the present invention provides a driving circuit, a driving method, and a display device, which are used to solve the technical problem that a current driving circuit has a large current on a common voltage line and damages a display screen.

To solve the above problems, the technical solutions provided in this application are as follows.

An embodiment of the present application provides a driving circuit applied to a display panel, comprising: a power management chip configured to output a common voltage to a common voltage driving module; and a control module configured to detect a current of the common voltage driving module during a blank time period in a display frame, and the control module controls the power management chip to stop outputting the common voltage when a current value of the common voltage driving module is greater than a preset value.

In an embodiment of the present application, the control module comprises a determination unit and a feedback unit, the determination unit is configured to determine the current value of the common voltage driving module and the preset value and transmit an obtained result to the feedback unit, the feedback unit is configured to continue detecting the common voltage driving module in a next display frame when the current value is less than the preset value, and the feedback unit is configured to control the power management chip to stop outputting the common voltage when the current value is greater than the preset value.

In an embodiment of the present application, the power management chip comprises a receiving module, the feedback module is configured to transmit a signal to the receiving module when the current value is greater than the preset value, and the receiving module is configured to stop the power management chip from outputting the common voltage when the signal is received.

In an embodiment of the present application, the control module is disposed in the power management chip, the power management chip is configured to detect a current of the common voltage driving module, and automatically stops when the current value of the common voltage driving module is greater than the preset value.

In an embodiment of the present application, the driving circuit further comprises a generating unit and a register, wherein the generating unit is configured to generate a first data when the driving circuit enters the blank time period in the display frame, and store the first data in the register, the control module is configured to start working when the first data in the register is read; the generating unit is further configured to generate a second data when the driving circuit enters a display time period in the display frame, and store the second data in the register, and the control module is configured to stop working when the second data in the register is read.

In an embodiment of the present application, the driving circuit further comprises a timing control chip electrically connected to the power management chip for outputting a clock signal; the register is disposed in the timing control chip, and the register is connected to the control module and is configured to transmit data to the control module.

In an embodiment of the present application, the driving circuit further comprises a timing control chip electrically connected to the power management chip for outputting a clock signal; the register is disposed in the timing control chip, the register is configured to transmit data to the power management chip, and the power management chip is configured to transmit a read data of the register to the control module.

In an embodiment of the present application, the driving circuit further comprises an alarm module electrically connected to the control module, the control module is configured to detect the current of the common voltage driving module during the blank time period in the display frame, and the alarm module is configured to issue a warning when the current value of the common voltage driving module is equal to the preset value.

In addition, an embodiment of the present application provides a driving method applied to the above driving circuit, comprising: the timing control chip communicating with the power management chip; the power management chip outputting the common voltage to the common voltage driving module; and the control module detecting the current of the common voltage driving module during the blank time period in the display frame and the control module controls the power management chip to stop outputting the common voltage when the current of the common voltage driving module is greater than the preset value.

In an embodiment of the present application, the step of the control module detecting the current of the common voltage driving module during the blank time period in the display frame further comprises that the control module stops working during a display time period in the display frame of the driving circuit.

In an embodiment of the present application, the step of the control module detecting the current of the common voltage driving module during the blank time period in the display frame further comprises: when the current of the common voltage driving module is less than the preset value, the control module continues to detect a next display frame of the common voltage driving module.

In addition, an embodiment of the present application provides a display device comprising the above driving circuit.

In an embodiment of the present application, the control module comprises a determination unit and a feedback unit, the determination unit is configured to determine the current value of the common voltage driving module and the preset value and transmit an obtained result to the feedback unit, the feedback unit is configured to continue detecting the common voltage driving module in a next display frame when the current value is less than the preset value, and the feedback unit is configured to control the power management chip to stop outputting the common voltage when the current value is greater than the preset value.

In an embodiment of the present application, the power management chip comprises a receiving module, the feedback module is configured to transmit a signal to the receiving module when the current value is greater than the preset value, and the receiving module is configured to stop the power management chip from outputting the common voltage when the signal is received.

In an embodiment of the present application, the control module is disposed in the power management chip, the power management chip is configured to detect a current of the common voltage driving module, and automatically stops when the current value of the common voltage driving module is greater than the preset value.

In an embodiment of the present application, the display device further comprises a generating unit and a register, wherein the generating unit is configured to generate a first data when the driving circuit enters the blank time period in the display frame, and store the first data in the register, the control module is configured to start working when the first data in the register is read; the generating unit is further configured to generate a second data when the driving circuit enters a display time period in the display frame, and store the second data in the register, and the control module is configured to stop working when the second data in the register is read.

In an embodiment of the present application, the first data comprises 1 and the second data comprises 0.

In an embodiment of the present application, the driving circuit further comprises a timing control chip electrically connected to the power management chip for outputting a clock signal; the register is disposed in the timing control chip, and the register is connected to the control module and is configured to transmit data to the control module.

In an embodiment of the present application, the driving circuit further comprises a timing control chip electrically connected to the power management chip for outputting a clock signal; the register is disposed in the timing control chip, the register is configured to transmit data to the power management chip, and the power management chip is configured to transmit a read data of the register to the control module.

In an embodiment of the present application, the display device further comprises an alarm module electrically connected to the control module, the control module is configured to detect the current of the common voltage driving module during the blank time period in the display frame, and the alarm module is configured to issue a warning when the current value of the common voltage driving module is equal to the preset value.

Beneficial effects of the present application are that embodiments of the application provide a driving circuit, a driving method, and a display device. The driving circuit is applied to a display panel. The driving circuit comprises a power management chip and a control module. The power management chip is configured to output a common voltage to a common voltage driving module. The control module is configured to detect a current of the common voltage driving module during a blank time period in a display frame, and the control module controls the power management chip to stop outputting the common voltage when a current value of the common voltage driving module is greater than a preset value. The driving circuit sets the control module, so that when a current value of the control module on the common voltage driving module is greater than the preset value, the power management chip is controlled to stop outputting a common voltage, so that when a current on a common voltage line is large, an output voltage to the common voltage driving module is stopped, thereby avoiding a phenomenon that a melting screen damages a display screen due to large current and solving the technical problem that a current driving circuit has a large current on a common voltage line and damages a display screen.

### DESCRIPTION OF DRAWINGS

FIG. 1 is a schematic diagram of a driving circuit according to an embodiment of the present application.

FIG. 2 is a schematic diagram of a driving time of a driving circuit according to an embodiment of the present application.

FIG. 3 is a flowchart of a driving method according to an embodiment of the present application.

FIG. 4 is a schematic diagram of a display module according to an embodiment of the present application.

### DETAILED DESCRIPTION OF PREFERRED EMBODIMENTS

The present application provides a driving circuit, a driving method, and a display device. In order to make the purpose, technical solution, and effect of the present application clearer and more definite, the present application is further described in detail below with reference to the accompanying drawings and examples. It is understood that the specific embodiments described herein are only used to explain the present application and are not used to limit the present application.

In view of the technical problem that a current driving circuit has a large current on a common voltage line and damages a display screen, embodiments of the present application are used to solve the issues.

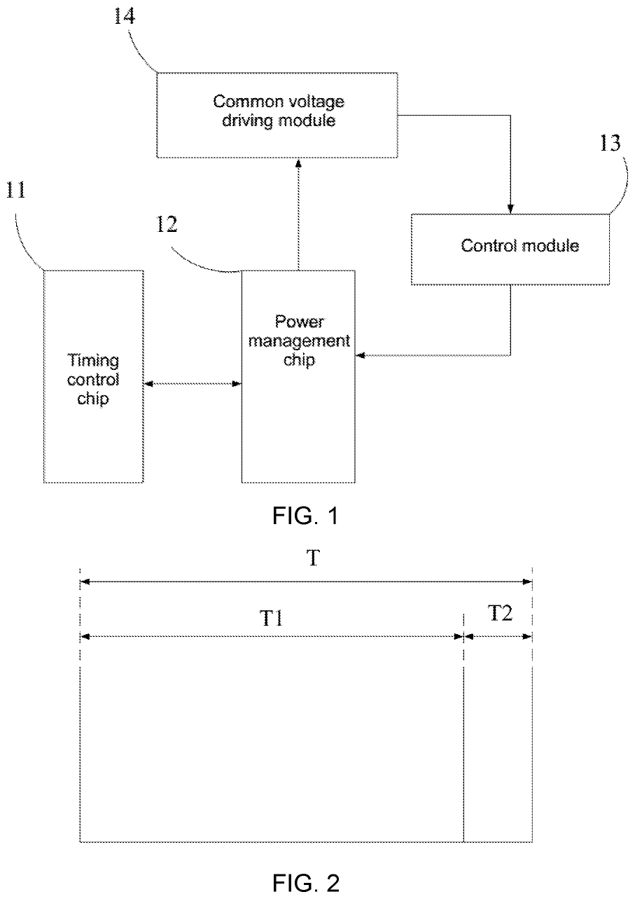

As shown in FIG. 1, an embodiment of the present application provides a driving circuit. The driving circuit includes:

A power management chip 12 configured to output a common voltage to a common voltage driving module 14.

A control module 13 configured to detect a current of the common voltage driving module 14 during a blank time period in a display frame, and the control module 13 controls the power management chip 12 to stop outputting the common voltage when a current value of the common voltage driving module 14 is greater than a preset value.

An embodiment of the application provides a driving circuit. The driving circuit is applied to a display panel. The driving circuit comprises a power management chip and a control module. The power management chip is configured to output a common voltage to a common voltage driving module. The control module is configured to detect a current of the common voltage driving module during a blank time period in a display frame, and the control module controls the power management chip to stop outputting the common voltage when a current value of the common voltage driving module is greater than a preset value. The driving circuit sets the control module, so that when a current value of the control module on the common voltage driving module is greater than the preset value, the power management chip is controlled to stop outputting a common voltage, so that when a current on a common voltage line is large, an output voltage to the common voltage driving module is stopped, thereby avoiding a phenomenon that a melting screen damages a display screen due to large current and solving the technical problem that a current driving circuit has a large current on a common voltage line and damages a display screen.

It should be noted that the preset value is a current value determined according to the driving circuit. The preset value is a value that is not greater than a current value that causes the display panel to melt the screen and is selected based on design and requirements of the driving circuit in the actual process.

In an embodiment of the present application, detecting the current can intuitively reflect whether the current is excessive during this time period and whether the current has caused damage to the display screen. In addition, the preset value is selected according to the current. For example, the preset value of the current can be selected as 10 mA.

In an embodiment, as shown in FIG. 1, the driving circuit further includes a timing control chip 11, which is electrically connected to the power management chip 12 and is configured to output a clock signal.

In an embodiment, as shown in FIG. 1, the power management chip and the timing control chip communicate through an I2C bus. When a common voltage needs to be output to the common voltage driving module, the timing control chip transmits a signal to the power management chip, so that the power management chip outputs the common voltage to the common voltage driving module.

In one embodiment, as shown in FIG. 2, a display frame T in the driving circuit includes a display time period T1 and a blank time period T2. The control module is configured to stop working during a display time period in a display frame of the driving circuit. Considering that the common voltage in the common voltage driving module changes greatly during the display time period, in order to avoid a wrong determination of the control module, the power management chip is stopped during the display time period, so that the display cannot be performed. During the display time period, the control module is stopped to make the display panel display normally during the display time period.

In an embodiment of the present application, the current on the common voltage driving module is detected during the blank time period in the display frame, which can avoid affecting the circuits in the display time period. In the blank time period, the circuits have no effect on the control module detecting the common voltage driving module, thereby avoiding wrong determination.

In one embodiment, when the driving circuit enters a blank time period in the display frame, the control module starts to work and detects the current on the common voltage driving module. When the current value on the common voltage driving module is greater than the preset value, the power management chip is stopped. When the control module detects the common voltage driving module, it can detect an input terminal and an output terminal of the common voltage driving module. When the current value of each common voltage driving module is greater than the preset value, it means that the current will cause damage to the display panel, and even a melting screen phenomenon will occur. This causes the power management chip to stop working and stop outputting current to the display panel, so that the display panel will not be damaged due to the large current. This solves the technical problem that the current driving circuit has a large current on the common voltage line and damages the display screen.

In one embodiment, the control module is configured to detect a current on the common voltage driving module during a blank time period in a display frame of the driving circuit. When the current value on the common voltage driving module is less than a preset value, the control module continues to detect the common voltage driving module in a next display frame of the driving circuit. When the control module detects the common voltage driving module in this display frame, the driving circuit works normally. The control module allows the control module to detect the common voltage driving module again in the next display frame, thereby keeping detection on the common voltage driving module. This avoids issues of damage to the display due to excessive common voltage.

In one embodiment, the control module comprises a determination unit and a feedback unit, the determination unit is configured to determine the current value of the common voltage driving module and the preset value and transmit an obtained result to the feedback unit. The feedback unit is configured to perform feedback according to the obtained result. When the control module detects the common voltage driving module, the determination unit obtains the current value of the common voltage driving module, compares the current value of the common voltage driving module with the preset value, and then transmits the comparison result to the feedback unit. After receiving the comparison result, the feedback unit performs feedback according to the comparison result.

In one embodiment, the feedback unit is configured to continue detecting the common voltage driving module in a next display frame when the current value is less than the preset value, and the feedback unit is configured to control the power management chip to stop outputting the common voltage when the current value is greater than the preset value. After receiving the comparison result, the feedback unit performs feedback according to the comparison result. When the current value is less than the preset value, that is, the current output by the common voltage driving module is a normal output current or the output current is a current that does not affect the display screen, and the feedback unit does not need to provide feedback to the power management chip, and the feedback unit can continue to perform feedback based on information transmitted by the determination unit in the next display frame. When the feedback unit receives a current value greater than the preset value, the feedback unit can transmit a signal to the power management chip to stop the power management chip, thereby avoiding damage to the display screen.

In one embodiment, the power management chip includes a receiving module, and the feedback module is configured to transmit a signal to the receiving module when the current value is greater than the preset value, and the receiving module is configured to stop the power management chip from outputting the common voltage when the signal is received.

In one embodiment, the control module is configured to detect a current on the common voltage driving module during a blank time period in the display frame. When the current value on the common voltage driving module is equal to the preset value, the control module stops the power management chip.

In one embodiment, the control module is configured to detect a current on the common voltage driving module during a blank time period in the display frame. When the current value on the common voltage driving module is equal to the preset value, the control module continues to detect the common voltage driving module in the next display frame.

In an embodiment of the present application, when the current value is equal to the preset value, the power management chip may be stopped, or a driving circuit may be operated, and the control module continues to detect the common voltage driving module in the next display frame, a warning message can also be issued, for example, a status is displayed on the display screen, and when the current value is equal to the preset value, a reaction is performed according to the needs in the actual use process.

When the current value of the common voltage driving module is equal to the preset value, an alarm module can be set so that the alarm module is connected to the control module. When the control module detects that the current value of the common voltage driving module is equal to the preset value, the alarm module warns a state through sound or display. This prevents further damage to the display screen when the current value of the common voltage driving module is greater than the preset value.

In one embodiment, the driving circuit further comprises an alarm module electrically connected to the control module, the control module is configured to detect the current of the common voltage driving module during the blank time period in the display frame, and the alarm module is configured to issue a warning when the current value of the common voltage driving module is equal to the preset value.

In one embodiment, the control module is disposed in the power management chip, the power management chip is configured to detect a current of the common voltage driving module, and automatically stops when the current value of the common voltage driving module is greater than the preset value. The control module is set in the power management chip. During the blank time period in the display frame, the control module in the power management chip detects the common voltage driving module. When the current value on the common voltage driving module is greater than the preset value, the power management chip automatically stops. During the display time period, the power management chip outputs a common voltage to the common voltage driving module. When the control module in the power management chip detects that the current value on the common voltage driving module is less than the preset value, the power management chip continues the work of the next display frame. The control module stops working in the display time period in the next display frame, and detects the common voltage driving module again in the blank time period in the next display frame. The control module works in the blank time period and can work independently. This makes the control module in the power management chip not affect other modules in the power management chip.

In one embodiment, the driving circuit further comprises a generating unit and a register, the generating unit is configured to generate a first data when the driving circuit enters the blank time period in the display frame, and store the first data in the register, the control module is configured to start working when the first data in the register is read; the generating unit is further configured to generate a second data when the driving circuit enters a display time period in the display frame, and store the second data in the register, and the control module is configured to stop working when the second data in the register is read. In order for the control module to detect the common voltage driving module when the driving circuit enters a blank time period in the display frame and in order to make the register store the first data when the driving circuit enters the blank time period in the display frame, when the control module reads the first data in the register, it starts to work. That is, the control module starts to work when the driving circuit enters the blank time period in the display frame. When the driving circuit enters the display time period in the display frame, the register stores the second data. This makes the control module stop working when it reads the second data in the register. That is, the control module does not perform detection during the display time period when the driving circuit enters the display frame to avoid disturbing the display.

In an embodiment, the register outputs the first data or the second data to the control module when receiving a signal from a driving chip. This makes the control module work during the blank time period in the display frame and stop working during the display time period in the display frame.

In an embodiment of the present application, the first data comprises 1 and the second data comprises 0.

In an embodiment of the present application, the driving circuit further comprises a timing control chip electrically connected to the power management chip for outputting a clock signal; the register is disposed in the timing control chip, and the register is connected to the control module and is configured to transmit data to the control module. The register is set in the timing control chip, so that the register transforms and outputs the first data and the second data according to the signal of the timing control chip. The register is electrically connected directly to the control module, and the control module performs a corresponding response according to the received data.

In an embodiment of the present application, the driving circuit further comprises a timing control chip electrically connected to the power management chip for outputting a clock signal; the register is disposed in the timing control chip, the register is configured to transmit data to the power management chip, and the power management chip is configured to transmit a read data of the register to the control module. Considering communication between the timing control chip and the power management chip, the register transmits the first data and the second data to the power management chip when the data is converted, and the power management chip transmits the data to the control module after receiving the data from the register. The control module responds according to the data transmitted by the power management chip.

In one embodiment, the register is disposed in the timing control chip, the control module is disposed in the power management chip, and the timing control chip communicates with the power management chip. The control module in the power management chip communicates with the register in the timing control chip, and the control module determines whether to work based on the data in the register.

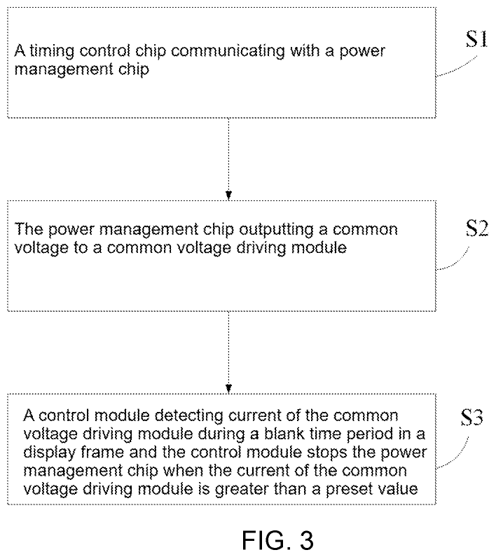

As shown in FIG. 3, an embodiment of the present application provides a driving method, which is applied to the driving circuit in any of the foregoing embodiments. The driving method of the driving circuit includes as follows.

S1, the timing control chip communicating with the power management chip.

S2, the power management chip outputting the common voltage to the common voltage driving module.

S3, the control module detecting the current of the common voltage driving module during the blank time period in the display frame and the control module stops the power management chip when the current of the common voltage driving module is greater than the preset value.

An embodiment of the application provides a driving method. A driving circuit using the driving method comprises a power management chip and a control module. The power management chip is configured to output a common voltage to a common voltage driving module. The control module is configured to detect a current of the common voltage driving module during a blank time period in a display frame, and the control module controls the power management chip to stop outputting the common voltage when a current value of the common voltage driving module is greater than a preset value. The driving circuit sets the control module, so that when a current value of the control module on the common voltage driving module is greater than the preset value, the power management chip is controlled to stop outputting a common voltage, so that when a current on a common voltage line is large, an output voltage to the common voltage driving module is stopped, thereby avoiding a phenomenon that a melting screen damages a display screen due to large current and solving the technical problem that a current driving circuit has a large current on a common voltage line and damages a display screen.

In one embodiment, the step of the control module detecting the current of the common voltage driving module during the blank time period in the display frame further comprises that the control module stops working during a display time period in the display frame of the driving circuit. During the display time period in the display frame, the control module stops working, so that the control module does not affect the display during the display time period, so that the display is normal.

In one embodiment, the step of the control module detecting the current of the common voltage driving module during the blank time period in the display frame further comprises: when the current of the common voltage driving module is less than the preset value, the control module continues to detect a next display frame of the common voltage driving module. When the current of the common voltage driving module is less than the preset value, the common voltage driving module in the next display frame continues to be detected, so that the common voltage driving module is continuously detected. This avoids large current output from the common voltage driving module and damages the display screen.

In one embodiment, the register receives signals from a driving chip. When a timing controller communicates with the power management chip, and the power management chip transmits a signal to the common voltage driving module, the register outputs the first data. The control module starts to work after receiving the first data, and detects the common voltage driving module. When the control module detects that the current value of the common voltage driving module is greater than the preset value, the control module transmits a signal to the power management chip to stop the power management chip. When the current value of the common voltage driving module is less than the preset value, the common voltage driving module does not transmit a signal to the power management chip, so that the power management chip continues to work. When the driving circuit enters the display time period in the display frame, the register outputs the second data to stop the control module from working, thereby avoiding interference with the display.

In one embodiment, after the power management chip stops working, after repairing short circuit or other circuit issues in an area, the power management chip is allowed to continue to work, so that the driving circuit continues to work.

In an embodiment of the present application, the control module detects the common voltage driving module in each display frame. In practice, a detection interval can be set according to requirements, for example, the common voltage driving module is detected at an interval of 1 minute.

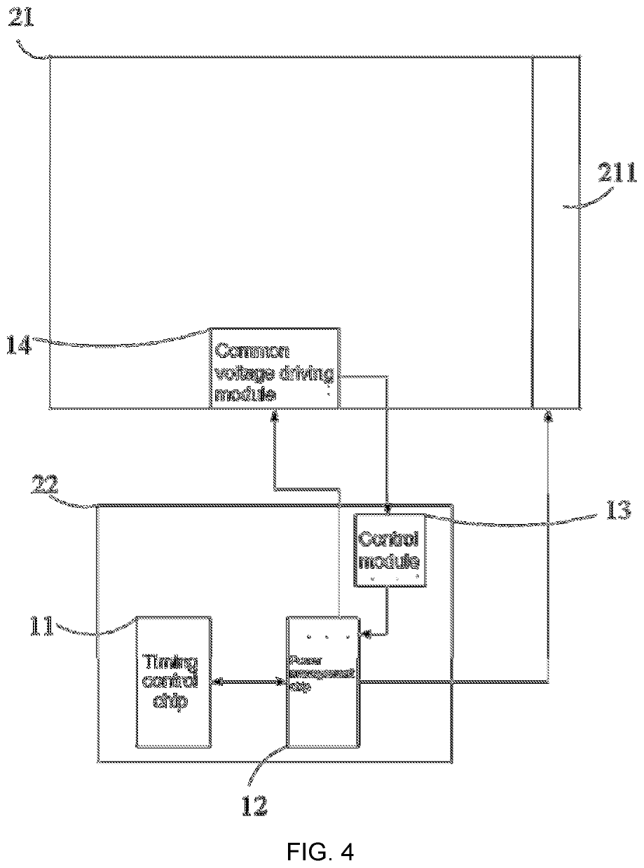

As shown in FIG. 4, an embodiment of the present application provides a display module. The display module includes as follows.

A display panel 21 includes a common voltage driving module 14 and a gate driving circuit 211.

A timing control board 22 includes a driving circuit including a power management chip 12 and a control module 13. The power management chip 12 is configured to output a common voltage to a common voltage driving module 14, the control module 13 configured to detect a current of the common voltage driving module 14 during a blank time period in a display frame, and the control module 13 stops the power management chip 12 when a current value of the common voltage driving module 14 is greater than a preset value.

In one embodiment, the power management chip is configured to output a driving voltage to the gate driving circuit. The control module includes a first control module and a second control module. The first control module is configured to detect a current on a common voltage driving module during a blank time period in a display frame, and control the power management to stop outputting a common voltage when a current value on the common voltage driving module is greater than a preset value. The second control module is configured to detect a current on a gate driving circuit during a blank time period in a display frame, and stop the power management when a current value on the gate driving circuit is greater than a preset value. The power management chip transmits a driving voltage to a gate driving circuit module. The driving voltage includes VGH (high potential signal) and VGL (low potential signal). The detection circuit can be used to detect the gate driving circuit module to avoid issues with the high-potential signal and the low-potential signal and damage to the gate driving circuit.

An embodiment of the present application provides a display device including the driving circuit described in any one of the above embodiments.

In one embodiment, in the display device, the control module comprises a determination unit and a feedback unit, the determination unit is configured to determine the current value of the common voltage driving module and the preset value and transmit an obtained result to the feedback unit, the feedback unit is configured to continue detecting the common voltage driving module in a next display frame when the current value is less than the preset value, and the feedback unit is configured to control the power management chip to stop outputting the common voltage when the current value is greater than the preset value.

In one embodiment, in the display device, the power management chip comprises a receiving module, the feedback module is configured to transmit a signal to the receiving module when the current value is greater than the preset value, and the receiving module is configured to stop the power management chip from outputting the common voltage when the signal is received.

In one embodiment, in the display device, the control module is disposed in the power management chip, the power management chip is configured to detect a current of the common voltage driving module, and automatically stops when the current value of the common voltage driving module is greater than the preset value.

In one embodiment, the display device further comprises a generating unit and a register, wherein the generating unit is configured to generate a first data when the driving circuit enters the blank time period in the display frame, and store the first data in the register, the control module is configured to start working when the first data in the register is read; the generating unit is further configured to generate a second data when the driving circuit enters a display time period in the display frame, and store the second data in the register, and the control module is configured to stop working when the second data in the register is read.

In one embodiment, in the display device, the first data comprises 1 and the second data comprises 0.

In one embodiment, in the display device, the driving circuit further comprises a timing control chip electrically connected to the power management chip for outputting a clock signal; the register is disposed in the timing control chip, and the register is connected to the control module and is configured to transmit data to the control module.

In one embodiment, in the display device, the driving circuit further comprises a timing control chip electrically connected to the power management chip for outputting a clock signal; the register is disposed in the timing control chip, the register is configured to transmit data to the power management chip, and the power management chip is configured to transmit a read data of the register to the control module.

In one embodiment, in the display device, the display device further comprises an alarm module electrically connected to the control module, the control module is configured to detect the current of the common voltage driving module during the blank time period in the display frame, and the alarm module is configured to issue a warning when the current value of the common voltage driving module is equal to the preset value.

It can be known from the above embodiments.

Embodiments of the application provide a driving circuit, a driving method, and a display device. The driving circuit comprises a power management chip and a control module. The power management chip is configured to output a common voltage to a common voltage driving module. The control module is configured to detect a current of the common voltage driving module during a blank time period in a display frame, and the control module controls the power management chip to stop outputting the common voltage when a current value of the common voltage driving module is greater than a preset value. The driving circuit sets the control module, so that when a current value of the control module on the common voltage driving module is greater than the preset value, the power management chip is controlled to stop outputting a common voltage, so that when a current on a common voltage line is large, an output voltage to the common voltage driving module is stopped, thereby avoiding a phenomenon that a melting screen damages a display screen due to large current and solving the technical problem that a current driving circuit has a large current on a common voltage line and damages a display screen.

It can be understood that, for a person of ordinary skill in the art, equivalent replacements or changes may be made according to the technical solution and the inventive concept of the present application. All these changes or replacements should fall within the protection scope of the claims attached to the present application.

What is claimed is:

1. A driving circuit applied to a display panel, comprising:
a power management chip configured to output a common voltage to a common voltage driving module; and
a control module configured to detect a current of the common voltage driving module during a blank time period in a display frame, and the control module controls the power management chip to stop outputting the common voltage when a current value of the common voltage driving module is greater than a preset value.

2. The driving circuit according to claim 1, wherein the control module comprises a determination unit and a feedback unit, the determination unit is configured to determine the current value of the common voltage driving module and the preset value and transmit an obtained result to the feedback unit, the feedback unit is configured to continue detecting the common voltage driving module in a next display frame when the current value is less than the preset value, and the feedback unit is configured to control the power management chip to stop outputting the common voltage when the current value is greater than the preset value.

3. The driving circuit according to claim 2, wherein the power management chip comprises a receiving module, the feedback module is configured to transmit a signal to the receiving module when the current value is greater than the preset value, and the receiving module is configured to stop the power management chip from outputting the common voltage when the signal is received.

4. The driving circuit according to claim 1, wherein the control module is disposed in the power management chip, the power management chip is configured to detect a current of the common voltage driving module, and automatically stops when the current value of the common voltage driving module is greater than the preset value.

5. The driving circuit according to claim 1, further comprising a generating unit and a register, wherein the generating unit is configured to generate a first data when the driving circuit enters the blank time period in the display frame, and store the first data in the register, the control module is configured to start working when the first data in the register is read; the generating unit is further configured to generate a second data when the driving circuit enters a display time period in the display frame, and store the second data in the register, and the control module is configured to stop working when the second data in the register is read.

6. The driving circuit according to claim 5, further comprising a timing control chip electrically connected to the power management chip for outputting a clock signal; wherein the register is disposed in the timing control chip, and the register is connected to the control module and is configured to transmit data to the control module.

7. The driving circuit according to claim 5, further comprising a timing control chip electrically connected to the power management chip for outputting a clock signal; wherein the register is disposed in the timing control chip, the register is configured to transmit data to the power management chip, and the power management chip is configured to transmit a read data of the register to the control module.

8. The driving circuit according to claim 1, further comprising an alarm module electrically connected to the control module, the control module is configured to detect the current of the common voltage driving module during the blank time period in the display frame, and the alarm module is configured to issue a warning when the current value of the common voltage driving module is equal to the preset value.

9. A driving method applied to the driving circuit according to claim 1, comprising:
the timing control chip communicating with the power management chip;
the power management chip outputting the common voltage to the common voltage driving module; and
the control module detecting the current of the common voltage driving module during the blank time period in the display frame and the control module controls the power management chip to stop outputting the common voltage when the current of the common voltage driving module is greater than the preset value.

10. The driving method according to claim 9, wherein the step of the control module detecting the current of the common voltage driving module during the blank time period in the display frame further comprises that the control module stops working during a display time period in the display frame of the driving circuit.

11. The driving method according to claim 9, wherein the step of the control module detecting the current of the common voltage driving module during the blank time period in the display frame further comprises: when the current of the common voltage driving module is less than the preset value, the control module continues to detect a next display frame of the common voltage driving module.

12. A display device comprising the driving circuit according to claim 1.

13. The display device according to claim 12, wherein the control module comprises a determination unit and a feedback unit, the determination unit is configured to determine the current value of the common voltage driving module and the preset value and transmit an obtained result to the feedback unit, the feedback unit is configured to continue detecting the common voltage driving module in a next display frame when the current value is less than the preset value, and the feedback unit is configured to control the power management chip to stop outputting the common voltage when the current value is greater than the preset value.

14. The display device according to claim 13, wherein the power management chip comprises a receiving module, the feedback module is configured to transmit a signal to the receiving module when the current value is greater than the preset value, and the receiving module is configured to stop the power management chip from outputting the common voltage when the signal is received.

15. The display device according to claim 12, wherein the control module is disposed in the power management chip, the power management chip is configured to detect a current of the common voltage driving module, and automatically stops when the current value of the common voltage driving module is greater than the preset value.

16. The display device according to claim 12, further comprising a generating unit and a register, wherein the generating unit is configured to generate a first data when the driving circuit enters the blank time period in the display frame, and store the first data in the register, the control module is configured to start working when the first data in the register is read; the generating unit is further configured to generate a second data when the driving circuit enters a display time period in the display frame, and store the second data in the register, and the control module is configured to stop working when the second data in the register is read.

17. The display device according to claim 12, wherein the first data comprises 1 and the second data comprises 0.

18. The display device according to claim 16, wherein the driving circuit further comprises a timing control chip electrically connected to the power management chip for outputting a clock signal; the register is disposed in the timing control chip, and the register is connected to the control module and is configured to transmit data to the control module.

19. The display device according to claim 16, wherein the driving circuit further comprises a timing control chip electrically connected to the power management chip for outputting a clock signal; the register is disposed in the timing control chip, the register is configured to transmit data to the power management chip, and the power management chip is configured to transmit a read data of the register to the control module.

20. The display device according to claim 12, further comprising an alarm module electrically connected to the control module, the control module is configured to detect the current of the common voltage driving module during the blank time period in the display frame, and the alarm module is configured to issue a warning when the current value of the common voltage driving module is equal to the preset value.
